(19) United States
(12) Patent Application Publication
(10) Pub. No.: US 2025/0367824 A1
(43) Pub. Date: Dec. 4, 2025

(54) ROBOT SYSTEM, ROBOT CONTROL DEVICE, AND TEACHING DEVICE

(71) Applicant: SEIKO EPSON CORPORATION, Tokyo (JP)

(72) Inventor: Daichi KAWAKAMI, MATSUMOTO-SHI (JP)

(21) Appl. No.: 19/219,486

(22) Filed: May 27, 2025

(30) Foreign Application Priority Data
May 30, 2024 (JP) 2024-087766

(51) Int. Cl. B25J 9/16

(52) U.S. Cl. CPC B25J 9/1653; B25J 9/1676

(57) ABSTRACT

A robot system includes an acquisition unit configured to acquire stop parameter information regarding a stop parameter corresponding to a condition regarding a stop of a predetermined portion on a robot arm when the robot arm is subjected to an emergency stop, a determination unit configured to determine whether to subject the robot arm to the emergency stop during an operation of the robot arm, and a drive control unit configured to execute a stop operation based on the stop parameter information when the determination unit determines to subject the robot arm to the emergency stop.

### CROSS-REFERENCE TO RELATED APPLICATIONS

The present application is based on, and claims priority from JP Application Serial Number 2024-087766, filed May 30, 2024, the disclosure of which is hereby incorporated by reference herein in its entirety.

### BACKGROUND OF THE INVENTION

### 1. Technical Field

The present disclosure relates to a robot system, a robot control device, and a teaching device.

### 2. Related Art

As described in JP-T-2008-532107, a robot system includes a robot including a robot arm, and a robot control device that transmits an operation command signal to the robot arm. In such a robot system, the robot control device transmits the operation command signal to the robot via a broadband network. Thus, the robot can be remotely controlled.

In such a robot system, the robot may be subjected to an emergency stop. In the robot system described in JP-T-2008-532107, when the robot arm is subjected to an emergency stop, if the robot arm is decelerated at a relatively large deceleration rate, the robot arm can be quickly stopped, but a load applied to each portion of the robot arm becomes large. On the other hand, if the robot arm is decelerated at a relatively small deceleration rate, a distance until the robot arm stops, that is, a braking distance becomes long, and safety is reduced. As described above, the robot system according to the related art is difficult to improve, when the robot arm is stopped, safety while reducing the load on each portion of the robot arm.

### SUMMARY OF THE INVENTION

A robot system according to an aspect of the present disclosure includes: an acquisition unit configured to acquire stop parameter information regarding a stop parameter corresponding to a condition regarding a stop of a predetermined portion on a robot arm when the robot arm is subjected to an emergency stop; a determination unit configured to determine whether to subject the robot arm to the emergency stop during an operation of the robot arm; and a drive control unit configured to execute a stop operation based on the stop parameter information when the determination unit determines to subject the robot arm to the emergency stop.

A robot control device according to an aspect of the present disclosure includes: a receiving unit configured to receive stop parameter information regarding a stop parameter corresponding to a condition regarding a stop of a predetermined portion on a robot arm when the robot arm is subjected to an emergency stop; a determination unit configured to determine whether to subject the robot arm to the emergency stop during an operation of the robot arm; and a drive control unit configured to execute a stop operation based on the stop parameter information when the determination unit determines to subject the robot arm to the emergency stop.

A teaching device according to an aspect of the present disclosure includes: an acquisition unit configured to acquire stop parameter information regarding a stop parameter corresponding to a condition regarding a stop of a predetermined portion on a robot arm when the robot arm is subjected to an emergency stop; and a transmitting unit configured to transmit the stop parameter information acquired by the acquisition unit to a robot control device that controls an operation of the robot arm, determines whether to subject the robot arm to the emergency stop during the operation of the robot arm, and executes a stop operation based on the stop parameter information when determining to subject the robot arm to the emergency stop.

### BRIEF DESCRIPTION OF DRAWINGS

FIG. 1 is a schematic configuration diagram of a robot system according to a first embodiment of the present disclosure.

FIG. 2 is a block diagram of the robot system illustrated in FIG. 1.

FIG. 3 is a diagram illustrating an example of a hardware configuration of the robot system illustrated in FIG. 1.

FIG. 4 is a schematic diagram for illustrating a trajectory of a control point of the robot arm.

FIG. 5 is a diagram for illustrating an operation of an emergency stop of the robot arm, and is a schematic diagram for illustrating a trajectory of a control point.

FIG. 6 is a flowchart for illustrating an example of a control operation performed by the robot system illustrated in FIG. 1.

FIG. 7 is a schematic diagram for illustrating a trajectory of a control point of a robot arm provided in a robot system according to a second embodiment of the present disclosure.

### DETAILED DESCRIPTION OF THE INVENTION

Hereinafter, a robot system, a robot control device, and a teaching device according to the present disclosure will be described in detail based on embodiments illustrated in the accompanying drawings.

### First Embodiment

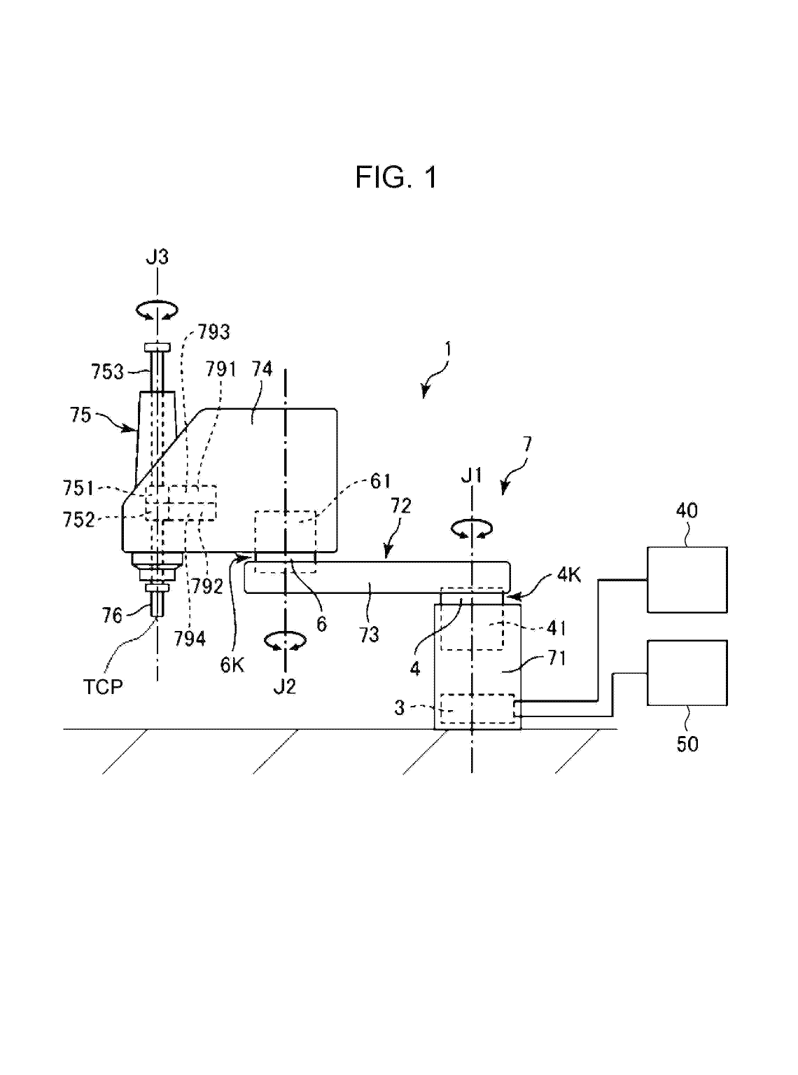

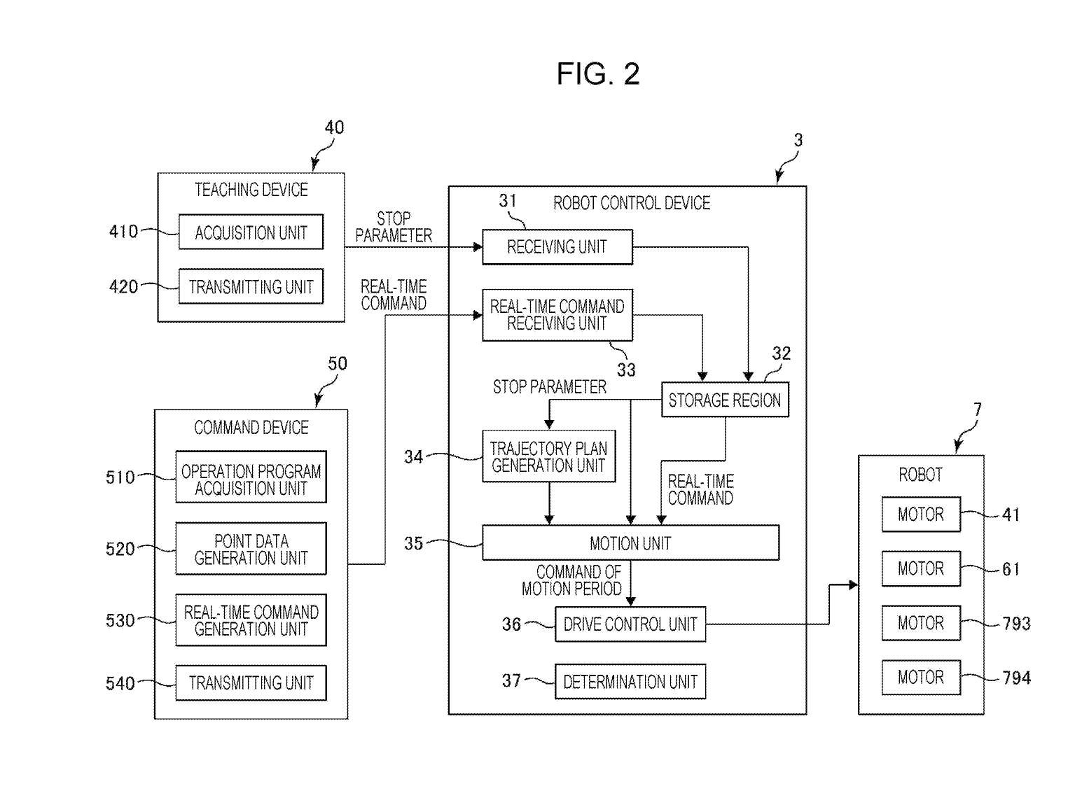

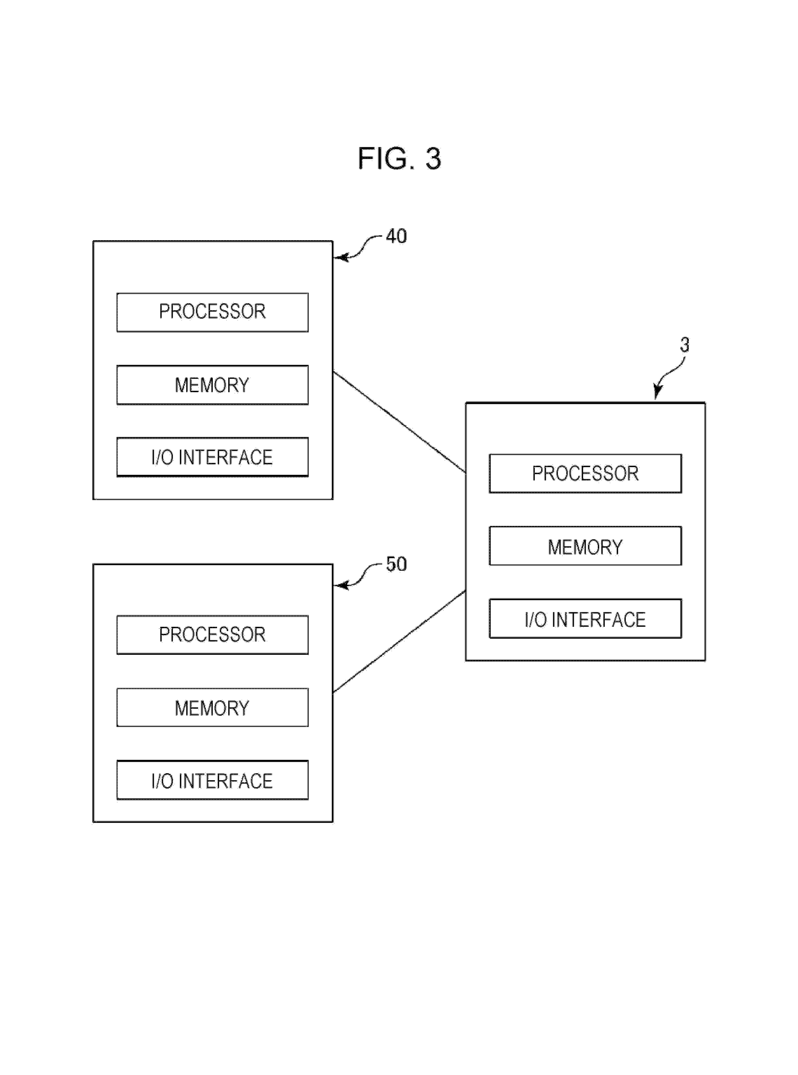

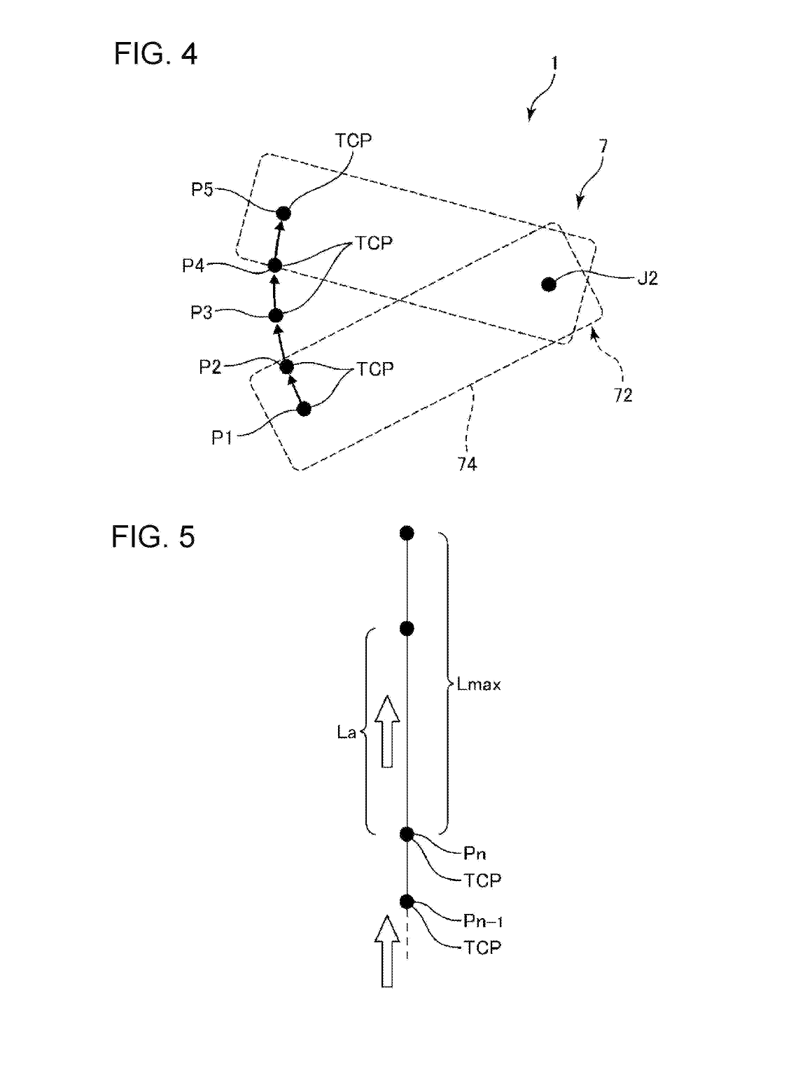

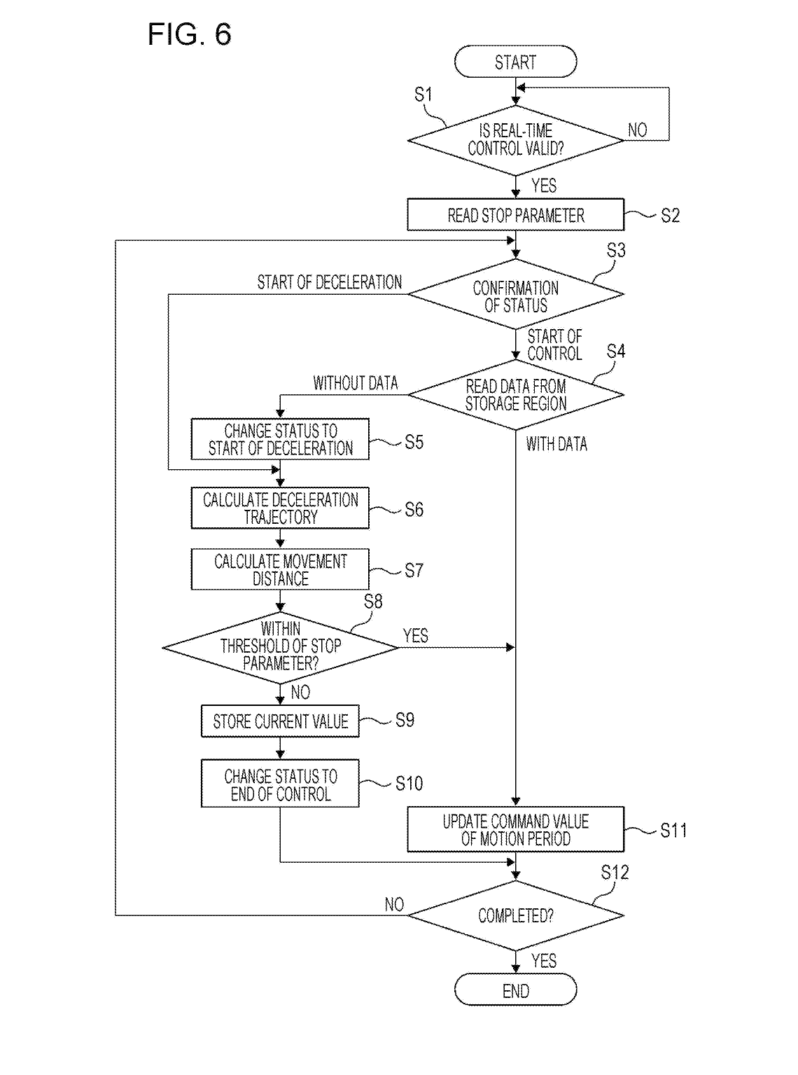

FIG. 1 is a schematic configuration diagram of a robot system according to a first embodiment of the present disclosure. FIG. 2 is a block diagram of the robot system illustrated in FIG. 1. FIG. 3 is a diagram illustrating an example of a hardware configuration of the robot system illustrated in FIG. 1. FIG. 4 is a schematic diagram for illustrating a trajectory of a control point of the robot arm. FIG. 5 is a diagram for illustrating an operation of an emergency stop of the robot arm, and is a schematic diagram for illustrating a trajectory of a control point. FIG. 6 is a flowchart for illustrating an example of a control operation performed by the robot system illustrated in FIG. 1.

It should be noted that an up-down direction in FIG. 1 coincides with a vertical direction, and an upper side and a lower side in FIG. 1 are also referred to as "upper" and "lower", respectively. Regarding a robot arm 72, a first arm 73, and a second arm 74, a right side in FIG. 1 is referred to as a "base end", and a left side is referred to as a "tip end".

In the description, a term "vertical" means not only a case where a direction is vertical, but also a case where a direction is slightly inclined with respect to the vertical direction, for example, within ± 10°. In the description, a term "parallel" means not only a case where two objects are parallel to each other, but also a case where two objects are slightly inclined with respect to the parallel direction, for example, within ± 10°.

As illustrated in FIGS. 1 and 2, the robot system 1 includes a robot 7, a robot control device 3 that controls driving of each part of the robot 7, a teaching device 40, and a command device 50.

In the present embodiment, the robot 7 is a SCARA robot, and is used in various operations such as holding, transporting, assembling, processing, and inspecting a work such as an electronic component. However, the use and type of operation of the robot 7 are not limited to those described above. In addition, the robot 7 may be, for example, a six-axis articulated robot or a double-arm robot other than the SCARA robot.

As illustrated in FIG. 1, the robot 7 includes a base 71 and the robot arm 72 rotatably connected to the base 71. The robot arm 72 includes a first arm 73 including a base end connected to the base 71 and rotating around a first rotation axis J1 in a vertical direction with respect to the base 71, and the second arm 74 including a base end connected to a tip end of the first arm 73 and rotating around a second rotation axis J2 in a vertical direction with respect to the first arm 73.

Further, as illustrated in FIG. 1, the robot control device 3 is built in the base 71, but, without being limited to such a configuration, the robot control device 3 may be configured separately from the robot 7.

A working head 75 is provided at the tip end of the second arm 74. The working head 75 includes a spline nut 751 and a ball screw nut 752 which are coaxially arranged at the tip end of the second arm 74, and a spline shaft 753 which is inserted through the spline nut 751 and the ball screw nut 752. The spline shaft 753 is rotatable around a third rotation axis J3, which is a central axis of the spline shaft 753, in the vertical direction with respect to the second arm 74, and is movable up and down in a direction along the third rotation axis J3.

A control point TCP is set at a lower end of the spline shaft 753. The control point TCP is a point serving as a reference for controlling the operation of the robot arm 72. The robot control device 3 grasps a position of the control point TCP in a certain coordinate system, and controls driving of a first joint portion 4K, a second joint portion 6K, a first driving mechanism 791, and a second driving mechanism 792 such that the control point TCP is located at a desired position.

An end effector 76 is attached to the lower end of the spline shaft 753. The end effector 76 is detachable from the spline shaft 753, and an end effector suitable for intended work is appropriately selected.

The robot 7 includes the first joint portion 4K which rotatably connects the base 71 and the first arm 73, and a motor unit 4 is installed in the first joint portion 4K to rotate the first arm 73 around the first rotation axis J1 with respect to the base 71.

In addition, the robot 7 includes the second joint portion 6K which rotatably connects the first arm 73 and the second arm 74, and a motor unit 6 is installed in the second joint portion 6K to rotate the second arm 74 around the second rotation axis J2 with respect to the first arm 73.

In addition, the robot 7 includes the first driving mechanism 791 that rotates the spline nut 751 to rotate the spline shaft 753 around the third rotation axis J3, and the second driving mechanism 792 that rotates the ball screw nut 752 to move up and down the spline shaft 753 in the direction along the third rotation axis J3, that is, in the vertical direction. The second driving mechanism 792 is installed below the first driving mechanism 791. The first driving mechanism 791 includes a motor 793, and the second driving mechanism 792 includes a motor 794. As illustrated in FIG. 2, the motors 793 and 794 are electrically connected to the robot control device 3. Conducting conditions to the motors 793 and 794, for example, conducting patterns, conducting timings, and conducting amounts are controlled by the robot control device 3.

The motor unit 4 includes a motor 41 and a power transmission mechanism (not illustrated) including, for example, a decelerator. The motor unit 6 includes a motor 61 and a power transmission mechanism (not illustrated) including, for example, a decelerator.

The motor 41 generates a driving force for rotating the first arm 73 with respect to the base 71. The motor 61 generates a driving force for rotating the second arm 74 with respect to the first arm 73. The motors 41 and 61 are not particularly limited, but are preferably servo motors, for example, AC servo motors or DC servo motors.

As illustrated in FIG. 2, the motors 41 and 61 are electrically connected to the robot control device 3. Although not illustrated, each of the motors 41 and 61 includes a stator, a rotor that rotates inside the stator, and a housing that houses these components. The stator is disposed along an inner periphery of the housing and has windings such as three-phase windings. The stator generates a magnetic field by conducting to the windings, for example, by conducting of a three-phase AC. In the motors 41 and 61, conducting patterns, conducting timings, and conducting amounts to the windings provided in the stator are controlled by the robot control device 3.

Each of the motors 793, 794, 41, and 61 includes a built-in motor driver (not illustrated).

The motors 793 and 794 may be similar to the motors 41 and 61, or may be motors with different types or configurations.

The power transmission mechanism in each of the motor units 4 and 6 transmits a driving force of a motor, which is a power source, to an adjacent arm, and includes at least one of a decelerator, a pulley, and an endless belt, for example. The decelerator is not particularly limited, and a decelerator of an eccentric oscillation type, a planetary gear type, a wave gear type, or the like can be used.

In such a robot system 1, the robot arm 72 being driven may be subjected to an emergency stop. An example of a cause of the emergency stop may include a case where another object approaches or collides with the robot arm 72, or a case where an abnormality occurs in reception of a command value in real-time control which will be described below. This will be described in detail below.

When the robot arm 72 is subjected to an emergency stop, if the robot arm 72 is decelerated at a relatively large deceleration rate, it is possible to quickly stop the robot arm 72, but a load applied to each portion of the robot arm 72, particularly, the first joint portion 4K, the second joint portion 6K, and the peripheral portion thereof increases. On the other hand, if the robot arm 72 is decelerated at a relatively small deceleration rate, a distance until the robot arm 72 stops, that is, a braking distance becomes long, and safety is reduced. As described above, when the robot arm 72 is stopped, it is difficult to improve safety while the load applied to each portion of the robot arm 72 is reduced. In the present disclosure, however, stop parameters are appropriately set which are conditions for an emergency stop according to a situation, and thus it is possible to achieve both of them, in particular, to perform weighting according to the priority. This will be described below.

First, the teaching device 40 and the command device 50 will be described. The teaching device 40 and the command device 50 are separate devices. However, the present disclosure is not limited to such a configuration, and the teaching device 40 and the command device 50 may be configured as a single device having functions described below.

As illustrated in FIG. 2, the teaching device 40 includes an acquisition unit 410 and a transmitting unit 420 as functional units.

The acquisition unit 410 acquires stop parameter information relating to stop parameters input by a user, for example.

The stop parameters are parameters corresponding to conditions related to the stop of a predetermined part on the robot arm 72, that is, the control point TCP, when the robot arm 72 is subjected to an emergency stop, and mainly includes a deceleration rate K of the speed of the control point TCP and an allowable braking distance Lmax which will be described below.

The stop parameter information includes information on the deceleration rate K of the speed of the control point TCP (a predetermined part on the robot arm 72) and information on the allowable braking distance Lmax until the stop, when the robot arm 72 is subjected to an emergency stop. In other words, the stop parameter information is information indicating an allowable braking distance at an allowable deceleration rate when the robot arm 72 is subjected to an emergency stop. For example, when the user inputs the values of the deceleration rate K and the allowable braking distance Lmax using an input device (not illustrated), the acquisition unit 410 acquires these pieces of information.

The allowable braking distance Lmax indicates a value of an allowable braking distance. The braking distance is a moving distance of the control point TCP (a predetermined part on the robot arm 72) from the start of deceleration of the robot arm 72 to the stop thereof.

When the user sets the deceleration rate K and the allowable braking distance Lmax, it is possible to designate the behavior of the robot arm 72 during the emergency stop.

The stop parameter information acquired by the acquisition unit 410 is transmitted to the robot control device 3 by the transmitting unit 420.

As illustrated in FIG. 2, the command device 50 includes, as functional units, an operation program acquisition unit 510, a point data generation unit 520, a real-time command generation unit 530, and a transmitting unit 540.

The operation program acquisition unit 510 acquires information relating to an operation program executed by the robot arm 72. The operation program includes position information of the control point TCP with the lapse of time, that is, point data, and information of the speed of the control point TCP between the respective pieces of point data.

The point data generation unit 520 converts the point data contained in the operation program acquired by the operation program acquisition unit 510 into point data in a coordinate system set for the robot 7.

The real-time command generation unit 530 generates a plurality of drive signals (hereinafter, referred to as "command values of motion periods") of the robot arm 72 from each piece of the point data generated by the point data generation unit 520.

Specifically, as illustrated in FIG. 4, in the robot system 1, the robot arm 72 is driven from a state in which the control point TCP is located at a target position P1 (in this case, the start point) so that the control point TCP is located at the next target position P2. Next, the robot arm 72 is driven from the state in which the control point TCP is located at the target position P2 so that the control point TCP is located at the next target position P3. When such an operation is repeated in the robot system 1, the robot arm 72 is driven so that the control point TCP sequentially passes through the target positions P1, P2, P3, P4, and P5. In this case, the position information on each of the target positions P1, P2, P3, P4, and P5 is point data. In addition, each of the command value for moving the control point TCP from the target position P1 to the target position P2, the command value for moving the control point TCP from the target position P2 to the target position P3, the command value for moving the control point TCP from the target position P3 to the target position P4, and the command value for moving the control point TCP from the target position P4 to the target position P5 is the command value of the motion period.

Namely, the control point TCP moves from the target position P1 to the target position P2 according to the command value of the first motion period, and moves from the target position P2 to the target position P3 according to the command value of the next motion period. By repetition of such an operation, the control point TCP can be moved from the target position P1 to the target position P5. The command value of the motion period is sequentially transmitted from the command device 50 and is stored in a storage region 32 of the robot control device 3 each time. For example, when the control point TCP is located at the target position P1, the command value of the motion period at the next target position P2 is transmitted from the command device 50 and stored in the storage region 32. As described above, the robot control device 3 drives the robot arm 72 while receiving the command values of the plurality of motion periods from the command device 50 in real time. In such real-time control, although the robot control device 3 does not grasp the final target position, the control performed by the robot control device 3 can be simplified, and the robot arm 72 can be controlled according to circumstances.

The transmitting unit 540 transmits the command values of the plurality of motion periods generated by the real-time command generation unit 530 to the robot control device 3.

As illustrated in FIG. 2, the robot control device 3 includes, as functional units, a receiving unit 31, the storage region 32, a real-time command receiving unit 33, a trajectory plan generation unit 34, a motion unit 35, a drive control unit 36, and a determination unit 37.

The receiving unit 31 receives the stop parameter information regarding the stop parameter from the teaching device 40. The received stop parameter information is stored in the storage region 32.

The real-time command receiving unit 33 receives the command values of a plurality of motion periods from the command device 50. The received command values of the plurality of motion periods are stored in the storage region 32.

The trajectory plan generation unit 34 reads the stop parameter information stored in the storage region 32 and generates a trajectory plan when the robot arm 72 is subjected to an emergency stop.

The motion unit 35 reads the command value of the motion period from the storage region 32, and transmits the latest command value to the drive control unit 36.

The drive control unit 36 drives each portion of the robot arm 72 based on the command value of the motion period received from the motion unit 35. The command value of a motion period contains a position command of a target position, and the position command is converted into information of an angle of each joint of the robot arm 72 to drive each portion of the robot arm 72.

As described above, the robot control device 3 drives the robot arm 72 while receiving the command values of the plurality of motion periods from the command device 50 in real time. Thus, the control performed by the robot control device 3 can be simplified, and the robot arm 72 can be controlled according to circumstances.

The determination unit 37 determines whether to subject the robot arm 72 to an emergency stop during the operation of the robot arm 72. In a case where the determination unit 37 determines to subject the robot arm 72 to the emergency stop, the drive control unit 36 executes a stop operation based on the stop parameter information.

The determination unit 37 determines to subject the robot arm 72 to the emergency stop when an abnormality occurs in the reception of the command value stored in the storage region 32. In other words, when the drive control unit 36 does not acquire the information of the next target position during the real-time control, the determination unit 37 determines to subject the robot arm 72 to the emergency stop. Thus, when the drive control unit 36 does not acquire the information of the next target position, the emergency stop can be performed, and safety can be improved.

The robot control device 3, the teaching device 40, and the command device 50 can be implemented as an example of a hardware configuration as illustrated in FIG. 3. Each of the robot control device 3, the teaching device 40, and the command device 50 includes at least one processor, a memory, and an I/O interface. The control unit, the storage unit, and the communication unit are communicably connected to each other via, for example, a bus.

The processor is constituted by, for example, a central processing unit (CPU), and reads and executes various programs stored in the memory.

The memory stores various programs and the like executed by the processor. Examples of the memory include a volatile memory such as a random access memory (RAM), a non-volatile memory such as a read only memory (ROM), and a detachable external storage device.

The I/O interface corresponds to a communication unit such as a wired local area network (LAN) or a wireless LAN. Accordingly, signals are transmitted and received between the robot control device 3, the teaching device 40, and the command device 50 or between these devices and an external device. In this case, the communication may be performed via a server (not illustrated), or via a network such as the Internet.

Next, an emergency stop operation of the robot arm 72 will be described with reference to FIG. 5.

FIG. 5 illustrates a trajectory of the control point TCP. The control point TCP moves from a lower side to an upper side in FIG. 5. Namely, the control point TCP moves in the order of a target position Pₙ₋₁ and a target position Pₙ. Here, n is an integer of 2 or more.

A case will be described in which the determination unit 37 determines to subject the robot arm 72 to an emergency stop when the control point TCP is located at the target position Pₙ.

In this case, the emergency stop is performed such that the braking distance of the control point TCP is equal to or less than the allowable braking distance Lmax contained in the stop parameter information. Specifically, a braking distance La, which is an estimated braking distance, is calculated based on the deceleration rate K of the speed of the control point TCP contained in the stop parameter information and the current speed of the control point TCP. In other words, the deceleration rate K is used to calculate the braking distance La when the robot arm 72 is subjected to the emergency stop.

When the braking distance La is equal to or less than the allowable braking distance Lmax, the emergency stop is performed using the deceleration rate K. Thus, the emergency stop can be performed without exceeding the allowable braking distance Lmax. On the other hand, when the calculated braking distance La exceeds the allowable braking distance Lmax, that is, if La > Lmax, the robot arm 72 is subjected to an emergency stop using a deceleration rate Ka larger than the deceleration rate K. The deceleration rate Ka is a relatively large deceleration rate set in advance, and is a value at which the braking distance can be sufficiently reduced, that is, a value at which high safety can be ensured. The deceleration rate Ka is stored in the storage region 32 as a set value.

When La > Lmax, the configuration is not limited to subjecting the robot arm 72 to an emergency stop using the deceleration rate Ka, but a configuration may be adopted in which the deceleration rate is recalculated so as to be the allowable braking distance Lmax or any allowable braking distance shorter than the allowable braking distance Lmax.

In the present disclosure described above, the robot arm 72 can stop within the allowable braking distance Lmax without the braking distance of the control point TCP exceeding the allowable braking distance Lmax set by the user. For example, the user can set the allowable braking distance Lmax to be relatively long in a case where the reduction of the load on each portion of the robot arm 72, particularly, the first joint portion 4K, the second joint portion 6K, and the peripheral portion thereof is prioritized over work accuracy and safety. Thus, it is possible to safely perform an emergency stop while sufficiently reducing the load on each portion of the robot arm 72. On the other hand, in a case where higher work accuracy and safety are required, the user can set the allowable braking distance Lmax to be relatively short. Thus, the robot arm 72 can be subjected to a quick emergency stop, and excellent work accuracy and safety can be ensured without applying an excessive load to each portion of the robot arm 72. According to the present disclosure as described above, the user can set the stop parameter, which can prevent an excessive load from being applied to each portion of the robot arm 72 at the time of emergency stop, improve work accuracy, and enhance safety. In particular, according to the set stop parameter, it is possible to perform an appropriate emergency stop operation according to the priority of reducing the load on each portion of the robot arm 72, improving the work accuracy, ensuring the safety or the like.

In the present embodiment, the stop parameter is set by the user, but, without being limited thereto, may be automatically set according to various conditions in the robot control device 3, the teaching device 40, the command device 50, or another external device, for example.

Further, as illustrated in FIG. 5, the movement direction of the control point TCP in the emergency stop operation (hereinafter, referred to as "stop operation") is an extension of the direction in which the control point TCP has moved. That is, the drive control unit 36 moves the robot arm 72 such that the control point TCP moves on an extension line of a line segment connecting the target position Pₙ (n being an integer of 2 or more) acquired last and the target position Pₙ₋₁ acquired immediately before the target position Pₙ. Accordingly, during the stop operation, it is possible to prevent excessive direction change and to prevent an excessive load from being applied to each portion of the robot arm 72. Particularly, it is effective in the real-time control since the robot control device 3 does not grasp the final target position.

As described above, the robot system 1 includes: the acquisition unit 410 that acquires the stop parameter information regarding the stop parameter corresponding to the condition regarding the stop of the predetermined part on the robot arm 72, that is, the control point TCP when the robot arm 72 is subjected to an emergency stop; the determination unit 37 that determines whether to subject the robot arm 72 to the emergency stop during the operation of the robot arm 72; and the drive control unit 36 that executes the stop operation based on the stop parameter information when the determination unit 37 determines to subject the robot arm 72 to the emergency stop. Thus, it is possible to perform the emergency stop operation of the robot arm 72 along the intention of the user according to the set stop parameter. In other words, it is possible to prevent an excessive load from being applied to each portion of the robot arm 72 during the emergency stop, and to improve work accuracy and safety. In particular, it is possible to perform an appropriate stop operation according to the priority of reducing the load on each portion of the robot arm 72, improving the work accuracy, ensuring the safety, or the like.

In the present embodiment, although the case has been described in which so-called real-time control is performed in which the robot control device 3 does not grasp the final target position of the robot arm 72 during the operation of the robot arm 72, the present disclosure is not limited thereto, and control may also be performed in which the robot control device 3 grasps the final target position of the robot arm 72.

In addition, although the predetermined part of the robot arm 72 has been described as the control point TCP, the present disclosure is not limited thereto, and the predetermined portion of the robot arm 72 may be a part other than the control point TCP, for example, a specific part on the second arm 74, a specific part on the work head 75, or a specific part on the end effector 76.

The stop parameter information includes information on the deceleration rate K of the speed of the control point TCP, which is a predetermined part, when the robot arm 72 is subjected to an emergency stop and information on the allowable braking distance Lmax until the robot arm 72 stops. Accordingly, a more appropriate stop operation can be performed.

The stop parameter information may include only one of the information of the deceleration rate K of the speed of the control point TCP and the information on the allowable braking distance Lmax until the stop. In addition, the stop parameter information may also include information on other parameters, for example, the speed of the control point TCP and the time until the stop.

When the determination unit 37 determines to subject the robot arm 72 to an emergency stop, the drive control unit 36 calculates the braking distance La when the robot arm is subjected to the emergency stop using the deceleration rate K, and subjects the robot arm 72 to the emergency stop using a deceleration rate Ka larger than the deceleration rate K when the calculated La satisfies a relationship of La > Lmax. As a result, a more appropriate stop operation can be performed.

Without being limited to the above configuration, for example, when the determination unit 37 determines to subject the robot arm 72 to an emergency stop, the drive control unit 36 may be configured to perform the emergency stop using the deceleration rate K without calculating the braking distance La when the robot arm is subjected to the emergency stop.

In addition, when the determination unit 37 determines to subject the robot arm 72 to an emergency stop, the drive control unit 36 may be configured to calculate a deceleration rate Kx such that the braking distance La is equal to or less than the allowable braking distance Lmax and to perform the emergency stop using the deceleration rate Kx.

The drive control unit 36 acquires information on the target position to which the predetermined part, that is, the control point TCP moves next, and repeats the operation of moving the robot arm 72 several times based on the acquired information on the target position, and when the drive control unit 36 does not acquire the information on the target position, the determination unit 37 determines to subject the robot arm 72 to an emergency stop. Thus, when the drive control unit 36 does not acquire the information of the next target position, the emergency stop can be performed, and safety can be improved.

The determination criterion for the determination unit 37 to determine to subject the robot arm 72 to an emergency stop is not limited to the above, and may be another condition, for example, whether the moving speed of the robot arm 72 is equal to or lower than a predetermined value.

Further, as described above, when the determination unit 37 determines to subject the robot arm 72 to an emergency stop, the drive control unit 36 moves the robot arm 72 onto the extension line of the line segment connecting the target position Pₙ (n being an integer of 2 or more) acquired last and the target position Pₙ₋₁ acquired immediately before the target position Pₙ. Accordingly, during the stop operation, it is possible to prevent excessive direction change and to prevent an excessive load from being applied to each portion of the robot arm 72. Particularly, it is effective in the real-time control since the robot control device 3 does not grasp the final target position.

Note that the present disclosure is not limited to the above-described configuration, and the drive control unit 36 may move, during the stop operation, the robot arm 72 in a direction deviated from the extension line of the line segment connecting the target position Pₙ and the target position P_{n -1} acquired immediately before the target position Pₙ.

The robot control device 3 includes the receiving unit 31 that receives the stop parameter information regarding the stop parameter corresponding to the condition regarding the stop of the predetermined part on the robot arm 72, that is, the control point TCP when the robot arm 72 is subjected to an emergency stop, the determination unit 37 that determines whether to subject the robot arm 72 to the emergency stop during the operation of the robot arm 72, and the drive control unit 36 that executes the stop operation based on the stop parameter information when the determination unit 37 determines to subject the robot arm 72 to the emergency stop. Thus, it is possible to perform the stop operation of the robot arm 72 along the intention of the user according to the set stop parameter. In other words, it is possible to prevent an excessive load from being applied to each portion of the robot arm 72 during the emergency stop, and to improve work accuracy and safety. In particular, it is possible to perform an appropriate stop operation according to the priority of reducing the load on each portion of the robot arm 72, improving the work accuracy, o ensuring the safety, or the like.

The teaching device 40 includes the acquisition unit 410 that acquires the stop parameter information regarding the stop parameter corresponding to the condition regarding the stop of the predetermined part on the robot arm 72, that is, the control point TCP when the robot arm 72 is subjected to an emergency stop, and the transmitting unit 420 that transmits the stop parameter information acquired by the acquisition unit 410 to the robot control device 3 that controls the operation of the robot arm 72, determines whether to subject the robot arm 72 to the emergency stop during the operation of the robot arm 72, and executes the stop operation based on the stop parameter information when it is determined to subject the robot arm 72 to the emergency stop. Thus, it is possible to perform the stop operation of the robot arm 72 along the intention of the user according to the set stop parameter. In other words, it is possible to prevent an excessive load from being applied to each portion of the robot arm 72 during the emergency stop, and to improve work accuracy and safety. In particular, it is possible to perform an appropriate stop operation according to the priority of reducing the load on each portion of the robot arm 72, improving the work accuracy, ensuring the safety, or the like.

Next, a control operation performed by the robot system 1 will be described with reference to a flowchart illustrated in FIG. 6.

First, it is determined in step S1 whether the real-time control is valid. The determination in this step is made based on an operation performed by the user from a switching operation screen (not illustrated) for switching ON/OFF of the real-time control.

In step S1, when it is determined to be valid (S1: YES), the stop parameter is read in step S2. That is, the acquisition unit 410 of the teaching device 40 acquires the stop parameter information input by the user, and the transmitting unit 420 transmits the stop parameter information to the robot control device 3.

Next, in step S3, a status is confirmed. That is, the drive control unit 36 of the robot control device 3 confirms and executes the command from the command device 50, and the determination unit 37 determines whether to perform an emergency stop.

Next, when it is determined in step S3 to be a start of control, the command value of the motion period received by the receiving unit 31 and stored in the storage region 32 is sequentially executed (step S4). When it is determined in step S3 to be a start of deceleration, the process proceeds to step S6.

In step S4, when there is a command value for the next motion period (step S4: with data), the command value of the motion period is updated and executed in step S11. Thereafter, it is determined in step S12 whether the operation is completed. This determination is made based on whether the completion signal has been received from the command device 50.

In step S4, when there is no command value of the next motion period (step S4: without data), the status is changed to a start of deceleration, that is, an emergency stop, in other words, a stop operation is started in step S5.

Next, in step S6, a deceleration trajectory is calculated. That is, in the emergency stop operation, as illustrated in FIG. 5, the drive control unit 36 determines a trajectory so as to move the robot arm 72 onto the extension line of the line segment connecting the target position Pₙ (n being an integer of 2 or more) acquired last and the target position Pₙ₋₁ acquired immediately before the target position Pₙ.

Next, in step S7, a movement distance is calculated. That is, the braking distance La, which is an estimated braking distance, is calculated based on the deceleration rate K of the speed of the control point TCP contained in the stop parameter information and the current speed of the control point TCP (see FIG. 5).

Next, it is determined in step S8 whether the braking distance is within the range of the stop parameter. That is, it is determined whether the braking distance La is equal to or less than the allowable braking distance Lmax, in other words, whether Lmax ≥ La.

When it is determined in step S8 that the braking distance La is equal to or less than the allowable braking distance Lmax (step S8: YES), the process proceeds to step S11. On the other hand, when it is determined in step S8 that the braking distance La exceeds the allowable braking distance Lmax, that is, the braking distance La is not within the range of the stop parameter (step S8: NO), the process proceeds to step S9.

In step S9, the current value is stored. That is, the current value is updated as the command value of the motion period, and an immediate stop is performed using the deceleration rate Ka larger than the deceleration rate K. Then, when the stop operation is completed, the status is changed to an end of control in step S10, and the program is ended.

On the other hand, the command value of the motion period is updated in step S11. That is, when the process proceeds from step S8 to step S11, the emergency stop is performed using the braking distance La and the deceleration rate K calculated in step S7.

Next, it is determined in step S12 whether the operation is completed, that is, whether the program is completed. In step S12, when it is determined that the program is completed (Step S12: YES), the process is ended, and when it is determined that the program is not completed (Step S12: NO), the process returns to Step S3, and the subsequent steps are sequentially repeated.

By performing such control, it is possible to perform the stop operation of the robot arm 72 based on the stop parameter set by the user. Therefore, it is possible to prevent an excessive load from being applied to each portion of the robot arm 72 during the emergency stop, and to improve work accuracy and safety.

### Second Embodiment

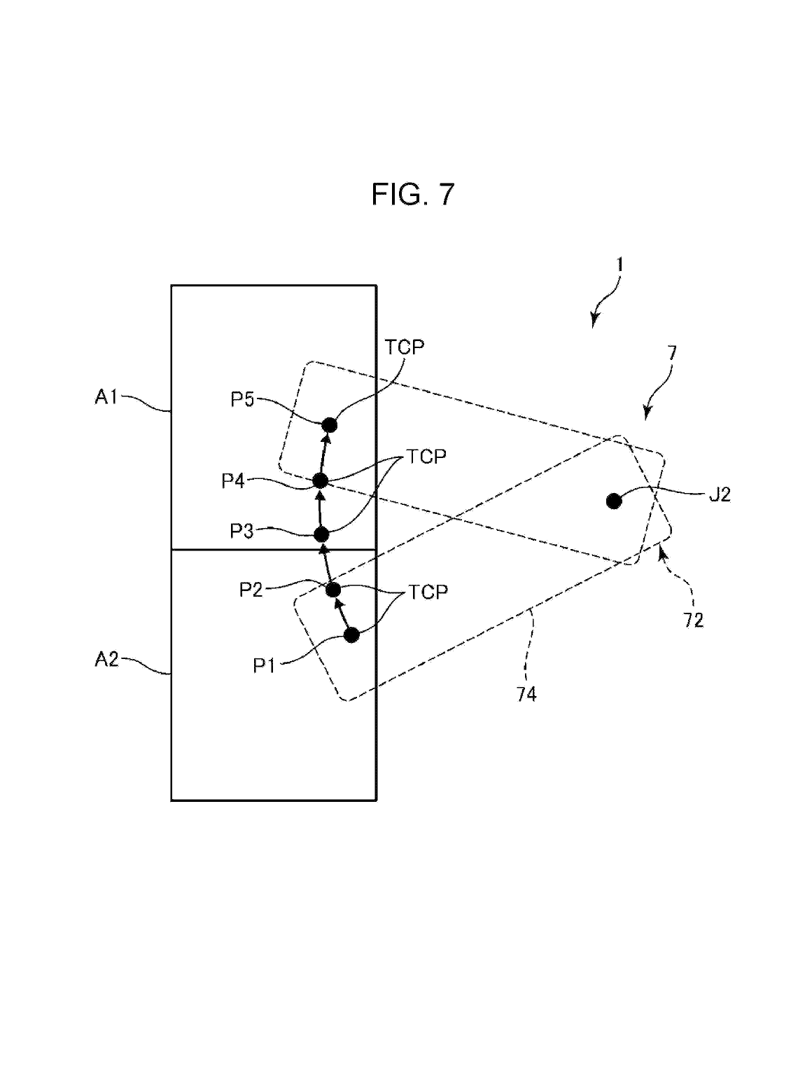

FIG. 7 is an enlarged partial cross-sectional view of an arm base of a second arm in a robot system according to a second embodiment of the present disclosure.

The robot and the robot system according to the second embodiment of the present disclosure will be described below with reference to FIG. 7. Differences from the first embodiment will be mainly described below without repeating description of similar parts.

As illustrated in FIG. 7, a first region A1 and a second region A2 different from the first region A1 are set as operation regions of the robot arm 72. The first region A1 and the second region A2 are adjacent to each other. The control point TCP of the robot arm 72 is movable within the first region A1 and the second region A2, and is also movable between the first region A1 and the second region A2. In other words, the movable region of the robot arm 72 includes the first region A1 and the second region A2. The first region A1 and the second region A2 are adjacent to each other in a horizontal direction, and are arranged in this order from the top in FIG. 7.

A first stop parameter and a second stopping parameter are set for the first region A1 and the second region A2, respectively. First stop parameter information contains the first stop parameter, and second stop parameter information contains the second stop parameter. The first stop parameter and the second stop parameter are set separately.

The user inputs first stop parameter information relating to a first stop parameter corresponding to the first region A1 and second stop parameter information relating to a second stop parameter corresponding to the second region A2, and the acquisition unit 410 of the teaching device 40 acquires the first stop parameter information and the second stop parameter information. Then, the transmitting unit 420 transmits the first stop parameter information and the second stop parameter information to the robot control device 3. The receiving unit 31 of the robot control device 3 receives the first stop parameter information and the second stop parameter information.

The first stop parameter information contains information on the deceleration rate K and the allowable braking distance Lmax as the first stop parameters, and the second stop parameter information contains information on the deceleration rate K and the allowable braking distance Lmax as the second stop parameters.

The first stop parameter information and the second stop parameter information have different values for the deceleration rate K and the allowable braking distance Lmax.

The first stop parameter information and the second stop parameter information may have the same value for either of the deceleration rate K and the allowable braking distance Lmax.

The robot control device 3 performs the stop operation based on the first stop parameter information and the second stop parameter information. Specifically, when the control point TCP is located within the first region A1, if the determination unit 37 determines to perform an emergency stop, the robot control device 3 performs the stop operation using the first stop parameter information in the same manner as in the first embodiment. On the other hand, when the control point TCP is located in the second region A2, if the determination unit 37 determines to perform an emergency stop, the robot control device 3 performs the stop operation using the second stop parameter information in the same manner as in the first embodiment.

For example, a case will be described in which an obstacle other than the robot arm 72 exists in the first region A1 and an obstacle other than the robot arm 72 does not exist in the second region A2. In this case, when the value of the deceleration rate K is set in the first stop parameter information to be relatively large and set the allowable braking distance Lmax to be relatively short, it is possible to further enhance the safety in the first region A1. On the other hand, when the value of the deceleration rate K is set in the second stop parameter information to be relatively small and set the allowable braking distance Lmax to be relatively long, it is possible to more effectively prevent an excessive load from being applied to each portion of the robot arm 72 during the stop operation.

In addition to the above, even when the robot arm 72 grips a work in the second region A2 and does not grip a work in the first region A1, if the first stop parameter information and the second stop parameter information are set in the same manner as described above, the safety can be improved since the robot arm 72 stops with a short braking distance in the first region A1 and unintentional release of the grip of the work due to deceleration accompanying the stop operation can be prevented or reduced in the second region A2.

In this way, according to the present embodiment, it is possible to take into consideration what kind of emergency stop operation is appropriate depending on the region in which the control point TCP exists. That is, for each of the first region A1 and the second region A2, it is possible to perform an appropriate stop operation according to the priority of reducing the load on each portion of the robot arm 72, improving the work accuracy, ensuring the safety, or the like. The user can set the first stop parameter information and the second stop parameter information for the first area A1 and the second area A2, respectively, in consideration of the priority. Therefore, it is possible to execute a more appropriate stop operation depending on an operating position of the robot arm 72.

As described above, the robot system 1 includes the first region A1 and the second region A2 different from the first region A1 as movable regions of the robot arm 72, and the acquisition unit 410 acquires, from the stop parameter information, the first stop parameter information relating to the first region A1 and the second stop parameter information relating to the second region A2. Accordingly, the user can set the first stop parameter information and the second stop parameter information while taking into consideration what kind of emergency stop operation is appropriate depending on the region in which the control point TCP exists. Therefore, it is possible to execute an appropriate stop operation for each of the first region A1 and the second region A2, and as a result, it is possible to execute a more appropriate stop operation as a whole.

In addition, the drive control unit 36 executes the stop operation based on the first stop parameter information in a case where the determination unit 37 determines to subject the robot arm 72 to an emergency stop when the control point TCP, which is a predetermined part of the robot arm 72, is located in the first region A1, and executes the stop operation based on the second stop parameter information in a case where the determination unit 37 determines to subject the robot arm 72 to an emergency stop when the control point TCP of the robot arm 72 is located in the second region A2. Accordingly, it is possible to perform an appropriate stop operation for each of the first region A1 and the second region A2, and as a result, it is possible to perform a more appropriate stop operation as a whole.

The first region A1 and the second region A2 may be set to be shifted in the vertical direction in FIG. 1 (direction perpendicular to the paper surface in FIG. 7).

In the embodiment described above, although a case has been described where the movable region of the robot arm 72 includes two regions of the first region A1 and the second region A2, the movable region may include three or more regions without being limited to two regions, and the stop parameter may be set for each of the regions.

In the above-described embodiment, the configuration has been described as an example in which the drive control unit 36 in the robot control device 3 converts the position command into the information on the angle of each joint of the robot arm 72 based on the command value of the motion period received from the command device 50 and drives each portion of the robot arm 72. However, the present disclosure is not limited to such a configuration, and for example, the command device 50 may be configured to calculate an angle command indicating the information on the angle of each joint of the robot arm 72 and transmit the angle command to the robot control device 3 as a command value of the motion period. In this case, the robot control device 3 does not need to convert the information into the information on the angle of each joint of the robot arm 72, and may be configured not to store the angle command, which is the command value of the motion period, in the storage region 32. When the command value of the motion period is not stored in the storage region 32, the command value of the motion period received by the receiving unit 31 may be sequentially executed after it is determined that the control is started in step S3 of the flowchart illustrated in FIG. 6.

Although the robot system, the robot control device, and the teaching device according to the present disclosure have been described above based on the respective embodiments illustrated in the drawings, the present disclosure is not limited thereto, and the configurations of the respective units in the robot system, the robot control device, and the teaching device can be replaced with any configurations having similar functions. In addition, any other components and functional units may be added to the robot system, the robot control device, and the teaching device.

1. A robot system comprising:
an acquisition unit configured to acquire stop parameter information regarding a stop parameter corresponding to a condition regarding a stop of a predetermined portion on a robot arm when the robot arm is subjected to an emergency stop;
a determination unit configured to determine whether to subject the robot arm to the emergency stop during an operation of the robot arm; and
a drive control unit configured to execute a stop operation based on the stop parameter information when the determination unit determines to subject the robot arm to the emergency stop.

2. The robot system according to claim 1, wherein the stop parameter information includes information on a deceleration rate K of a speed of the predetermined portion when the robot arm is subjected to the emergency stop and information on an allowable braking distance Lmax until the robot arm stops.

3. The robot system according to claim 2, wherein, when the determination unit determines to subject the robot arm to the emergency stop, the drive control unit calculates, using the deceleration rate K, a braking distance La when the robot arm is subjected to the emergency stop, and when La > Lmax, the drive control unit subjects the robot arm to the emergency stop using a deceleration rate Ka larger than the deceleration rate K.

4. The robot system according to claim 1, wherein the drive control unit repeats an operation of acquiring information on a target
position to which the predetermined portion is to be moved next and moving the robot arm based on the acquired information on the target position a plurality of times, and the determination unit determines to subject the robot arm to the emergency stop when the drive control unit does not acquire the information on the target position.

5. The robot system according to claim 4, wherein, when the determination unit determines to subject the robot arm to the emergency stop, the drive control unit moves the robot arm on an extension line of a line segment connecting a target position Pn acquired last and a target position Pn-1 acquired immediately before the target position Pn n being an integer of 2 or more.

6. The robot system according to claim 1, wherein the robot arm has, as movable regions of the robot arm, a first region and a second region different from the first region, and the acquisition unit acquires, from the stop parameter information, first stop parameter information regarding the first region and second stop parameter information regarding the second region.

7. The robot system according to claim 6, wherein the drive control unit executes the stop operation based on the first stop parameter information in a case where the determination unit determines to subject the robot arm to the emergency stop when the predetermined portion of the robot arm is located in the first region, and executes the stop operation based on the second stop parameter information in a case where the determination unit determines to subject the robot arm to the emergency stop when the predetermined portion of the robot arm is located in the second region.

8. A robot control device comprising:
a receiving unit configured to receive stop parameter information regarding a stop parameter corresponding to a condition regarding a stop of a predetermined portion on a robot arm when the robot arm is subjected to an emergency stop;
a determination unit configured to determine whether to subject the robot arm to the emergency stop during an operation of the robot arm; and
a drive control unit configured to execute a stop operation based on the stop parameter information when the determination unit determines to subject the robot arm to the emergency stop.

9. A teaching device comprising:
an acquisition unit configured to acquire stop parameter information regarding a stop parameter corresponding to a condition regarding a stop of a predetermined portion on a robot arm when the robot arm is subjected to an emergency stop; and
a transmitting unit configured to transmit the stop parameter information acquired by the acquisition unit to a robot control device that controls an operation of the robot arm, determines whether to subject the robot arm to the emergency stop during the operation of the robot arm, and executes a stop operation based on the stop parameter information when determining to subject the robot arm to the emergency stop.
